(19) United States
(12) Patent Application Publication
(10) Pub. No.: US 2005/0081210 A1
(43) Pub. Date: Apr. 14, 2005

(54) Dynamic adjustment of system resource allocation during query execution in a database management system

(75) Inventors: Paul Reuben Day, Rochester, MN (US); Brian Robert Muras, Rochester, MN (US); Anne Marie Ryg, Mantorville, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/671,043

(22) Filed: Sep. 25, 2003

(51) Int. Cl. G06F 9/46

(52) U.S. Cl. 718/104

(57) ABSTRACT

An apparatus, program product and method dynamically and temporarily adjust resource allocation in a computer system during execution of a database query to maximize the performance of the computer system in executing the database query. A desirable resource allocation for optimally executing a particular database query on a computer system may be determined during generation of an access plan for that database query. In association with such a determination, a request for adjusting the resource allocation may be supplied to a resource manager in the computer system to initiate the adjustment of system resources in the computer system prior to actual execution of the access plan. As a result, when the access plan is ultimately executed, the resource allocation may be adjusted in the manner specified in the request to provide an optimal environment for executing the access plan, thus enabling a proactive adjustment of resource allocation to occur in advance of future activity.

### FIELD OF THE INVENTION

The invention relates to database management systems, and in particular, to the allocation of system resources used by database management systems.

### BACKGROUND OF THE INVENTION

Databases are used to store information for an innumerable number of applications, including various commercial, industrial, technical, scientific and educational applications. As the reliance on information increases, both the volume of information stored in most databases, as well as the number of users wishing to access that information, likewise increases. Moreover, as the volume of information in a database, and the number of users wishing to access the database, increases, the amount of computing resources required to manage such a database increases as well.

Database management systems (DBMS's), which are the computer programs that are used to access the information stored in databases, therefore often require tremendous resources to handle the heavy workloads placed on such systems. As such, significant resources have been devoted to increasing the performance of database management systems with respect to processing searches, or queries, to databases.

Improvements to both computer hardware and software have improved the capacities of conventional database management systems. For example, in the hardware realm, increases in microprocessor performance, coupled with improved memory management systems, have improved the number of queries that a particular microprocessor can perform in a given unit of time. Furthermore, the use of multiple microprocessors and/or multiple networked computers has further increased the capacities of many database management systems. From a software standpoint, the use of relational databases, which organize information into formally-defined tables consisting of rows and columns, and which are typically accessed using a standardized language such as Structured Query Language (SQL), has substantially improved processing efficiency, as well as substantially simplified the creation, organization, and extension of information within a database.

Furthermore, significant development efforts have been directed toward query “optimization,” whereby the execution of particular searches, or queries, is optimized in an automated manner to minimize the amount of resources required to execute each query. A query optimizer typically generates, for each submitted query, an access plan, which typically incorporates low-level information telling the database engine that ultimately handles a query precisely what steps to take (and in what order) to execute the query. In addition, the access plan may select from different access methods (e.g., table scans or index accesses), based upon the available resources in the system.

Often, the performance of a computer system in handling database queries is highly dependent upon the availability and utilization of system resources in the computer system. Many computer systems are designed to handle a large number of tasks simultaneously, and as a result, the manner in which system resources such as memory, processors, storage and the like are made available to different tasks (as well as the manner in which tasks are distributed to system resources such as machines in a distributed computer system) can have a significant impact on overall system performance, not to mention the performance of each individual task.

For example, many computer system architectures rely on the use of memory pools to allocate memory resources among competing tasks in a computer system. In many of these architectures, the amount of memory in a memory pool, as well as the maximum activity level (representing the maximum number of threads that are permitted to concurrently use the memory pool), is configurable, at least during creation of the memory pool. In general, increasing the size of a memory pool increases the performance of the tasks that use the memory pool, as the likelihood of having to swap data between the memory pool and virtual storage is often reduced. Furthermore, limiting the maximum activity in the memory pool also increases performance for those tasks that use the memory pool, as there is less competition for the finite resources in the memory pool.

On the other hand, system resources such as memory are finite, so any time the size of a memory pool is increased, or a more restrictive limitation on maximum activity is placed on a memory pool, it comes at the expense of other tasks executing in the computer system. Resource management is often a game of tradeoffs, where limited resources are allocated to different tasks to achieve an acceptable performance for all of the tasks.

In some architectures, the concept of dynamic resource allocation is supported. For example, some architectures support performance adjuster software that may be used to monitor system activity and periodically adjust resource allocation in a computer system based upon the monitored activity. In the case of memory pools, performance adjuster software is often capable of reconfiguring memory pool size and maximum activity based upon recent observations on memory pool usage.

From the perspective of a database management system, the currently available resources allocated throughout a computer system can impact the manner in which particular access plans are selected during optimization of database queries. Particularly when available resources are limited, the number of available execution strategies is often limited, and often the most efficient strategies are eliminated from consideration.

As an example, the implementation of a GROUP BY operation in a query might be capable of being performed either using index grouping or hash grouping, with the former taking 10 seconds to complete and the latter taking only 5 seconds. However, if the available resources do not exist to use hash grouping (e.g., if the query's fair share of the memory pool, representative of the pool size divided by the maximum activity, is too small to hold the necessary hash table), then the latter option may not be selected, resulting in longer execution time, and consequently lower performance.

This problem may be even more prevalent for infrequently used long running queries. Particularly when resource allocation in a computer system is configured to provide optimal performance for less costly and more frequently executed queries, there is a substantial likelihood that the resource allocation settings in the computer system will not be optimally configured to efficiently execute less frequent, and more costly queries.

Accordingly, a continuing need exists in the art for a manner of optimizing the performance of a computer system when executing different types of database queries, and particularly when executing database queries having varying resource allocation requirements.

### SUMMARY OF THE INVENTION

The invention addresses these and other problems associated with the prior art by providing an apparatus, program product and method that dynamically and temporarily adjust resource allocation in a computer system during execution of a database query to maximize the performance of the computer system in executing the database query.

In illustrated embodiments consistent with the invention, for example, a desirable resource allocation for optimally executing a particular database query on a computer system may be determined during generation of an access plan for that database query. In association with such a determination, a request for adjusting the resource allocation may be supplied to a resource manager in the computer system to initiate the adjustment of system resources in the computer system prior to actual execution of the access plan. As a result, when the access plan is ultimately executed, the resource allocation may be adjusted in the manner specified in the request to provide an optimal environment for executing the access plan. It will be appreciated, however, that the illustrated embodiments are exemplary in nature, and therefore, the invention is not limited to these specific embodiments.

Therefore, consistent with one aspect of the invention, a dynamic and temporary adjustment to resource allocation is performed responsive to a request for a temporary allocation of system resources for a database query to be executed in the future, such that the query is executed under the adjusted resource allocation.

Consistent with another aspect of the invention, a determination of an adjustment to a resource allocation in a computer system is made in association with the generation of an access plan for a database query, such that the access plan is executed while the adjustment is applied to the resource allocation in the computer system.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system incorporating a database management system within which is implemented dynamic resource allocation adjustment consistent with the invention.

FIG. 2 is a block diagram illustrating the principal components and flow of information therebetween in the database management system of FIG. 1.

FIG. 3 is a flowchart illustrating the program flow of a process incoming query routine executed by the query optimizer of FIG. 2.

FIG. 4 is a flowchart illustrating the program flow of a process incoming allocation request routine executed by the resource manager of FIG. 2.

### DETAILED DESCRIPTION

The embodiments discussed hereinafter dynamically and temporarily adjust resource allocation in a computer system during execution of a database query to maximize the performance of the computer system in executing the database query. Typically, such a dynamic adjustment of resource allocation is made via a request to a resource manager during construction of an access plan for a database query, such that the resource allocation of the system may be adjusted as specified in the request in advance of execution of the access plan. As a result, a database management system is able to effectively adapt resource allocation in a computer system to optimize execution of a database query.

Embodiments consistent with the invention may be used to adjust the allocation of a number of types of resources that may be resident in a computer system. For example, resources such as memory resources, processor resources, input/output resources, and storage resources accessible to a computer (as well as combinations thereof) may be dynamically and temporarily allocated in the manner described herein. Furthermore, in distributed computer systems where multiple computers or machines are networked together, those specific computers or machines may themselves be considered resources that may be allocated to handle a database query in the manner described herein. Therefore, while the embodiments described below will focus on an implementation of the invention in which the resource being allocated is memory from one or more memory pools, it will be appreciated that the invention is not limited to this particular application.

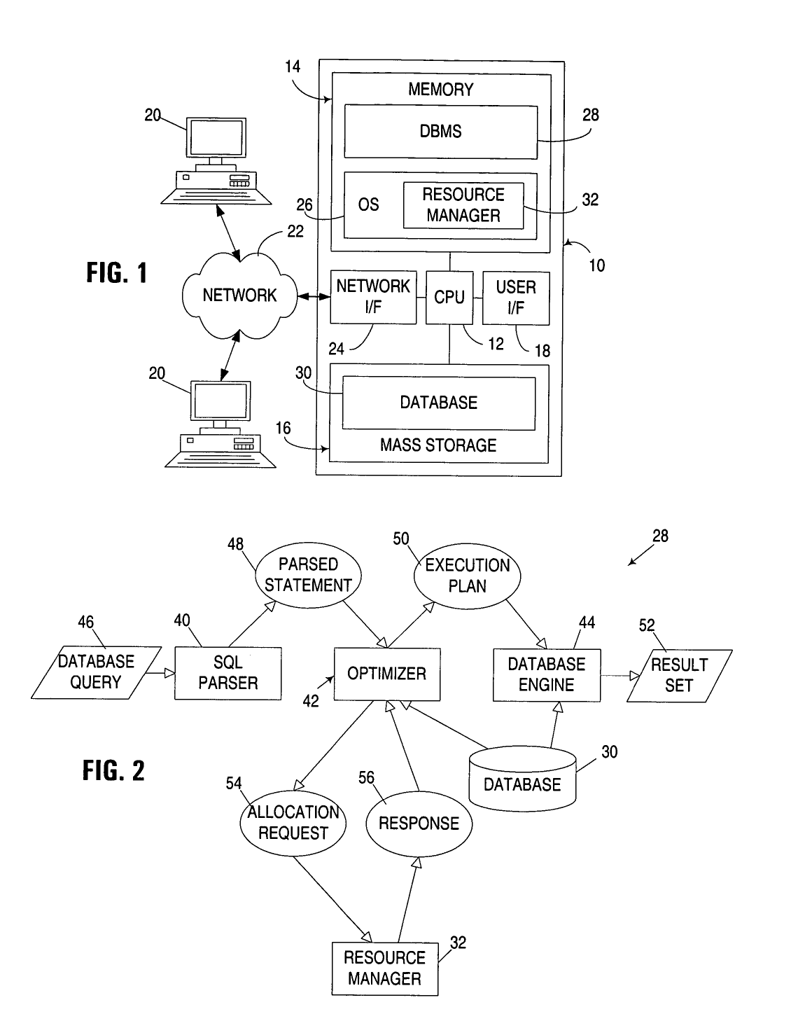

Turning now to the Drawings, wherein like numbers denote like parts throughout the several views, FIG. 1 illustrates an exemplary hardware and software environment for an apparatus 10 suitable for implementing a database management system incorporating dynamic resource allocation adjustment consistent with the invention. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated that the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 16 or on another computer coupled to computer 10.

Computer 10 also typically receives a number of inputs and outputs for communicating information externally. For interface with a user or operator, computer 10 typically includes a user interface 18 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal, e.g., via a client or single-user computer 20 coupled to computer 10 over a network 22. This latter implementation may be desirable where computer 10 is implemented as a server or other form of multi-user computer. However, it should be appreciated that computer 10 may also be implemented as a standalone workstation, desktop, or other single-user computer in some embodiments.

For non-volatile storage, computer 10 typically includes one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 24 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14, 16, 18, and 24 as is well known in the art.

Computer 10 operates under the control of an operating system 26, and executes or otherwise relies upon various computer software applications, components, programs, objects, modules, data structures, etc. For example, a database management system (DBMS) 28 may be resident in memory 14 to access a database 30 resident in mass storage 16. In addition, a resource manager 32 may be incorporated into operating system 26 to manage the allocation of resources in computer 10 in a manner that will become more apparent below.

Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

FIG. 2 next illustrates in greater detail the principal components in one implementation of DBMS 28. The principal components of DBMS 28 that are generally relevant to query execution are an SQL parser 40, optimizer 42 and database engine 44. SQL parser 40 receives from a user (or more typically, an application executed by that user) a database query 46, which in the illustrated embodiment, is provided in the form of an SQL statement. SQL parser 40 then generates a parsed statement 48 therefrom, which is passed to optimizer 42 for query optimization. As a result of query optimization, an execution or access plan 50 is generated. Once generated, the execution plan is forwarded to database engine 44 for execution of the database query on the information in database 30. The result of the execution of the database query is typically stored in a result set, as represented at block 52.

Dynamic resource allocation adjustment is initiated in the embodiment of FIG. 2 via the issuance of allocation requests 54 from query optimizer 42. As will be discussed in greater detail below, each allocation request is passed to resource manager 32 to request a temporary allocation resources for a period of time sufficient to execute a selected access plan. As will also be discussed in greater detail below, resource manager 32 is configured to either grant or deny each allocation request, and provide a response 56 to query optimizer 42 indicating whether each allocation request has or has not been granted.

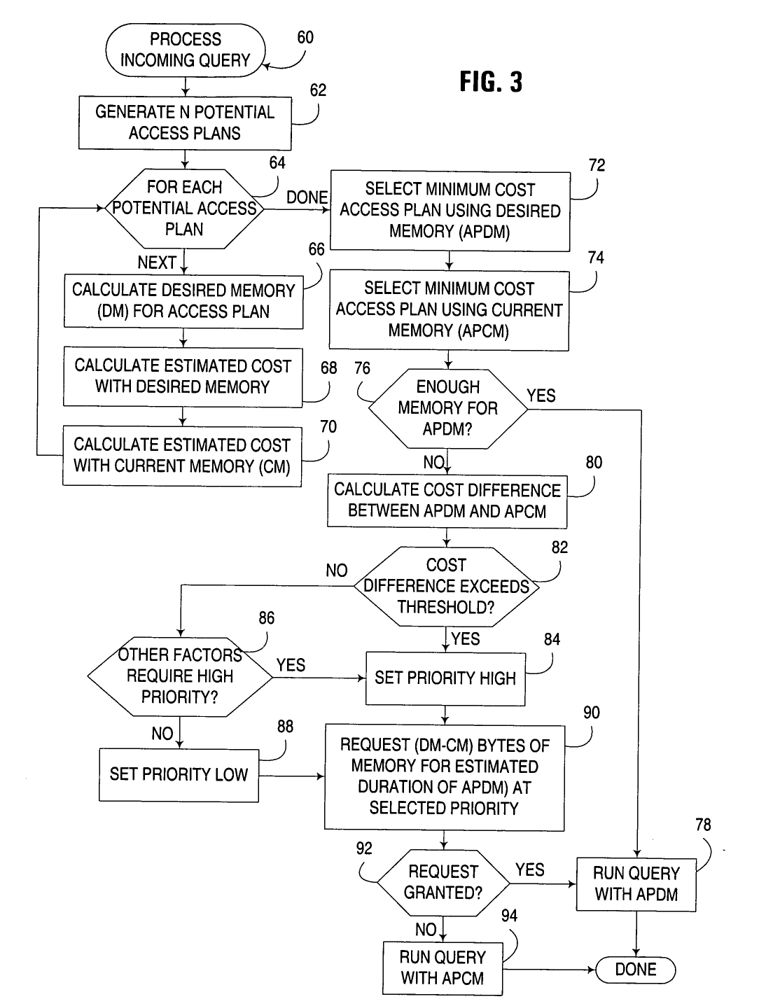

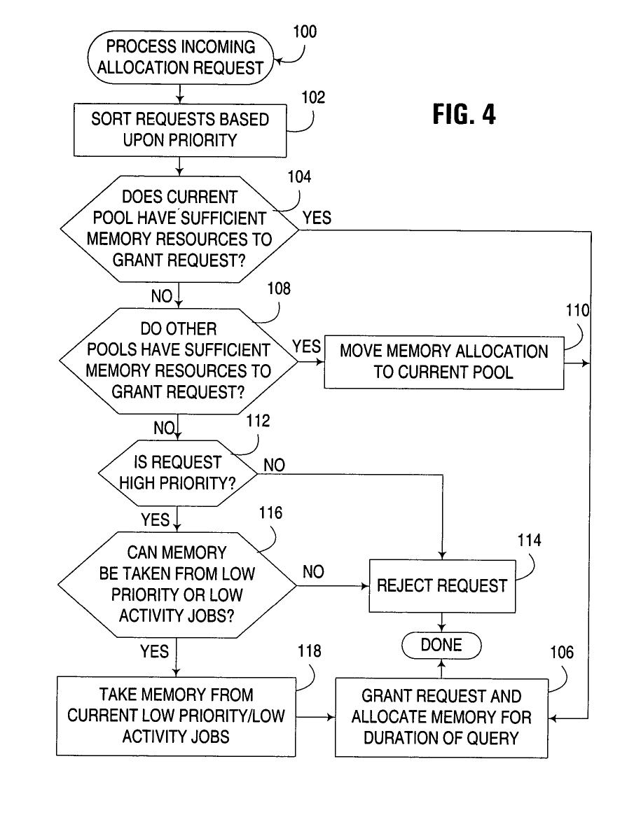

Now turning to FIGS. 3 and 4, an exemplary implementation of the invention, within which the particular resource being allocated is limited to memory in a memory pool, is illustrated in greater detail. Such an implementation may be utilized, for example, in an eServer iSeries computer from International Business Machines Corporation executing a DB2 database management system, along with a performance adjuster program resident in an OS/400 operating system. The determination of additional memory required to properly execute an access plan, and the ability to issue allocation requests to initiate a dynamic resource allocation adjustment, is implemented within the query optimizer component of the DB2 database management system, while the handling of requests and the actual reallocation of system resources responsive thereto is implemented within the performance adjuster program.

On the iSeries computer, the performance adjustor program automatically determines an optimal pool size and maximum activity level, depending on the setting of system value QPFRADJ, and by constraints set in a WRKSHRPOOL command. Even when the performance adjustor program is active, however, memory pools and maximum activity levels are only typically adjusted on twenty second boundaries. Outside of the request-based reallocation discussed in greater detail herein, however, the performance adjustor program typically bases its decisions on recent observations, but has no knowledge of what the system load may look like in the near future.

The iSeries computer does allow individual jobs to be assigned to different memory pools, and as such, could enable a query to be run in a separate memory pool. However, doing so would be inefficient, particularly if a query is not run on a frequent basis. Moreover, typically if a query is not run on a frequent basis, its memory pool would be tuned down over time by the performance adjuster program, possibly rendering the memory pool insufficient for later executions of the query.

In addition, the iSeries computer does provide a Change Query Attributes (CHGQRYA) command to change the amount of memory to be used to run a query, via a DEGREE value, which may be set to either a value of *OPTIMIZE or *MAX. With DEGREE set to *OPTIMIZE, the query optimizer makes its decisions assuming it can use only its fair share of the memory pool. With DEGREE set to *MAX, the optimizer assumes that fifty percent of the available memory pool can be used to process the query. However, this setting is static until changed back to *OPTIMIZE, and does not take into account other activity in the system.

In the illustrated embodiment, however, additional adjustments may be made to the performance adjustor program responsive to requests made by a query optimizer. For example, it may be desirable to provide a system value, e.g., QQPFRADJ, that may be set to enable a query optimizer to override or temporarily adjust maximum activity level and/or memory pool size when building an access plan. It may also be desirable to provide a command, such as WRKQRYADJ, to enable a user to define the limits of the adjustments that may be initiated by a query optimizer.

It will be appreciated, however, that the implementation of the invention in this specific environment, with this specific type of system resource, and with the specific delegation of duties to the query optimizer and performance adjuster, is merely exemplary in nature. The invention is therefore not limited to the particular implementation discussed herein.

FIG. 3 illustrates a process incoming query routine 60 executed by query optimizer 42 of FIG. 2 in response to reception of a parsed statement 48 generated by SQL parser 40. Routine 60 begins in block 62 by generating N potential access plans that may be considered to execute the database query, using any number of conventional access plan generation algorithms.

Next, block 64 initiates a FOR loop to calculate the estimated costs for each generated plan. The cost of an access plan in this implementation is represented by an estimated period of time required to complete the query, e.g., in seconds or another time interval. Other performance characteristics may be used to represent the cost of an access plan, e.g., processor cycles, memory consumption, input/output bandwidth, and combinations thereof.

For each access plan, block 64 passes control to block 66 to calculate the desired memory (DM) for the access plan. The desired memory represents the amount of memory in a memory pool that the access plan would require to execute efficiently. For example, where a given access plan relies on tools such as indexes, bitmaps, hash tables, tables, internal buffers, internal data structures, etc., the desired memory typically represents the amount of memory necessary to store all of the relied-upon tools in memory at the same time. In some embodiments, the desired memory may only be sufficient to store a portion of an index, hash table, etc., so long as the amount of memory swapping that would occur as a result of only storing a portion does not significantly degrade performance.

Next, block 68 calculates the estimated cost for the access plan assuming that the desired memory was available, and block 70 calculates the estimated cost for the access plan under current memory (CM) available for executing the query(e.g., the query's “fair share” of a memory pool, representative of the memory pool size divided by maximum activity). It will be appreciated that estimating the cost of an access plan may use any conventional costing algorithm, with the algorithm supplied the desired and current memory based upon the memory assumptions supplied. Control then returns to block 64 to process additional access plans.

Once all access plans are costed, block 64 passes control to block 72 to select the minimum cost access plan assuming the desired memory was available to execute the query, designated as the access plan desired memory (APDM). Block 74 likewise selects the minimum cost access plan given the currently available memory, designated as the access plan current memory (APCM).

Control then passes to block 76 to determine whether enough memory is available to satisfy the memory requirements for the APDM access plan, e.g., by determining if DM for the APDM access plan is less than or equal to CM. If so, control passes to block 78 to initiate the execution of the query using the APDM access plan, e.g., by passing the APDM access plan to database engine 44 of FIG. 2. Execution of the query is then complete.

Otherwise, if insufficient memory exists to satisfy the memory requirements of the APDM access plan, block 76 passes control to block 80 to begin constructing an allocation request to the resource manager to attempt to obtain the additional memory necessary to meet the requirements of the APDM access plan.

In particular, block 80 calculates the cost difference between the APDM and APCM access plans. Where costs are represented by estimated period of time required to execute the access plan, for example, the cost difference by represent the time difference between the estimated times of the APDM and APCM access plans, or alternatively, a ratio between the estimated times.

Next, block 82 determines whether the cost difference exceeds a threshold, representing a substantial difference in cost. For example, if it is determined that the cost difference is greater than a fixed threshold, e.g., x seconds, or is greater than a variable threshold, e.g., x times the estimated time for the APCM access plan, it may be determined that the benefit of obtaining the necessary additional memory is significant enough to warrant indicating a high priority for the request. As a result, if the threshold is met, block 82 passes control to block 84 to set the priority of the request to high.

On the other hand, if the threshold is not met, block 82 passes control to block 86 to determine whether any other factors may warrant designating the request as high priority. For example, if the priority of the job under which the query is executing is high, it may be desirable to designate the request as high priority as well. Also, in some embodiments, it may be desirable to permit individual queries to be designated as high priority queries independent from the priorities of the jobs within which such queries are executed.

If any considerations do warrant making a high priority request, block 86 passes control to block 84 to designate the allocation request as high priority. Otherwise, block 86 passes control to block 88 to designated the allocation request as low priority. It will be appreciated that in different embodiments, priorities may not be used, or additional priority levels may be designated. Moreover, different thresholds may be used, as may different factors. The invention is therefore not limited to the particular implementation discussed herein.

After priority is set in either block 84 or block 88, control passes to block 90 to formulate an allocation request for the additional memory necessary to execute the APDM access plan. The allocation request in this implementation specifies an additional amount of memory, which may be determined, for example, by taking the difference of DM for the APDM access plan and CM. In the alternative, the difference may be rounded up (e.g., to the next full kilobyte or megabyte of memory). The request also specifies the priority set in either block 84 or block 88.

In addition, the allocation request in this implementation specifies a duration, which defines an endpoint when the requested allocation adjustment can be released. The duration may be defined in terms of a time interval, and may be determined, for example, from the estimated cost for the APDM access plan, or alternatively, for some time interval that exceeds the estimated cost by a desired margin. As with the memory, the duration may be rounded up if desirable.

In the alternative, the duration may be based upon a completion criterion, e.g., when execution of the query is complete. As such, it may be desirable to provide feedback to the resource manager to indicate that execution of the query is complete, and that the requested resource allocation adjustment is no longer required. In such an instance, no duration may need to be specified in a request. In the alternative, a resource manager may be configured to support both “end of query” and fixed time interval durations, whereby the duration specified in a request may select between different modes of operation.

Once the request is generated, the allocation request is forwarded to the resource manager, and routine 60 waits for a response to the allocation request. Once the response is received, control passes to block 92 to determine whether the request was granted. If granted, control passes to block 78 to execute the query using the APDM access plan. Otherwise, control passes to block 94 to execute the query using the APCM access plan, representing the minimum cost access plan under current memory availability. Routine 60 is then complete.

FIG. 4 next illustrates a process incoming allocation request routine 100 executed by resource manager 32 in response to reception of an allocation request. Routine 100 begins in block 102 by sorting requests by priority, should multiple requests be pending, so that high priority requests are handled before any lower priority requests.

Next, block 104 determines whether the current memory pool (e.g., the memory pool that will be used by the query during execution) has sufficient memory resources to grant the request. For example, if the number of threads currently using the current memory pool is below the maximum activity setting for the memory pool, additional memory from the memory pool typically may be allocated from the current memory pool, e.g., by temporarily reducing the maximum activity setting for the memory pool, or by granting a thread or job multiple “slices” of the memory pool (where each slice would be a “fair share” value equal to the memory pool size divided by the maximum activity setting for the pool).

If the current memory pool does have sufficient resources, control passes to block 106 to grant the request (typically by sending a “grant” response to the query optimizer) and allocate the requested memory for the duration specified in the request. At the end of the duration, the additional memory is typically deallocated, returning the resource allocation to that which existed prior to receiving the request. Routine 100 is then complete. As noted above, the deallocation of the additional memory may occur after a requested time interval, or after detecting completion of execution of the database query.

Returning to block 104, if the current memory pool lacks sufficient resources, control passes to block 108 to determine whether any other memory pool has sufficient resources to grant the request. If so, control passes to block 110 to move memory allocation from one of the memory pools having sufficient resources to the current pool, e.g., by removing memory from another memory pool and adding that memory to the current pool. . Control then passes to block 106 to grant the request and dynamically and temporarily allocate the additional memory for the duration specified in the request.

Returning to block 108, if no other pool has sufficient memory resources, control passes to block 112 to determine if the request has a high priority. If not, control passes to block 114 to reject the request by sending a “deny” response to the query optimizer. Routine 100 is then complete.

If the request is high priority, however, block 112 passes control to block 116 to determine whether any memory is available to be taken from a low priority and/or low activity job resident in the system. If not, control passes to block 114 to reject the request and terminate routine 100. Otherwise, control passes to block 118 to take memory from one or more low priority and/or low activity jobs. Control then passes to block 106 to grant the request and dynamically and temporarily allocate the memory in the manner noted above. Routine 100 is then complete.

It will be appreciated that a resource manager typically is aware of how much memory is actually used by each job, and can thus determine what jobs have unused memory. Moreover, a resource manager may be configured to reserve a percentage of memory to support basic system services, but make the other memory available for reallocation in the manner discussed herein.

It will also be appreciated that other factors may be utilized to determine whether or not to grant a request, including factors such as the current system workload, the available memory within a memory pool, the number of current jobs and/or threads in a given memory pool, and/or the rate of change of activity in a memory pool, among others. Furthermore, other manners of manipulating a memory pool may be used to effectively allocate additional memory to execute a query, including adjusting memory pool size and/or adjusting maximum activity, among others. Therefore, the invention is not limited to the particular routines discussed herein.

The issuance of requests and return of responses may be implemented via a number of different manners consistent with the invention. One such manner is to provide an interface for the resource manager that is accessible by the query optimizer. For example, one interface between the query optimizer and the performance adjuster in the illustrated embodiment may take the form of:

QueryPerformanceMemoryRequest(BytesRequested, Duration, PriorityOfRequest)

Thus, for example, if a query was estimated to take 1000 seconds to group by index versus 5 seconds to group by hash if the query had 25 MB more of memory, the request may be given a high priority (given the significant discrepancy between 1000 seconds and 5 seconds), resulting in the issuance of the following request:

QueryPerformanceMemoryRequest(25 MB, 5 Seconds, High)

On the other hand, if the group by index was estimated at 7 seconds and the group by hash criteria was 5 seconds if it had more memory, the query optimizer might issue the request:

QueryPerformanceMemoryRequest(25 MB, 5 Seconds, Low)

The herein-described embodiments provide a number of benefits over conventional designs. Most notably, rather than relying solely on historical data, a resource manager consistent with the invention may be effectively provided with predictive data representative of the likely system workload in the near future, thus enabling the resource manager to dynamically adjust resource allocation in advance of future activity. Moreover, data regarding other system activity may be used to determine whether or not certain resource allocation requests are granted, thus providing elements of fairness along with the granting of additional resources to improve the performance of certain database queries.

Various modifications may be made to the illustrated embodiments without departing from the spirit and scope of the invention. Therefore, the invention lies in the claims hereinafter appended.

1. A method of dynamically adjusting database performance in a computer system, the method comprising:
receiving a request for a temporary allocation of a system resource for a database query to be executed in the future; and
dynamically and temporarily adjusting resource allocation in the computer system in response to receiving the request such that the database query is executed under the adjusted resource allocation.

2. The method of claim 1, wherein receiving the request and dynamically and temporarily adjusting resource allocation is performed by a performance adjuster that periodically adjusts resource allocation in the computer system.

3. The method of claim 1, wherein the system resource is selected from the group consisting of a memory resource, a processor resource, an input/output resource, a storage resource, and a machine resource.

4. The method of claim 1, wherein the database query is allocated to a memory pool in the computer system, wherein the request specifies at least one adjusted parameter for the memory pool, and wherein dynamically and temporarily adjusting resource allocation includes adjusting the memory pool based upon the specified at least one adjusted parameter.

5. The method of claim 4, wherein the adjusted parameter specifies a reduction in maximum activity permitted in the memory pool, and wherein dynamically and temporarily adjusting resource allocation includes reducing maximum activity permitted in the memory pool to that specified in the request.

6. The method of claim 4, wherein the adjusted parameter specifies additional memory to be allocated to the memory pool, and wherein dynamically and temporarily adjusting resource allocation includes allocating the specified additional memory to the memory pool.

7. The method of claim 4, wherein the request additionally specifies a duration, and wherein dynamically and temporarily adjusting resource allocation includes readjusting the memory pool after the specified duration.

8. The method of claim 7, wherein the duration specified in the request identifies a time interval, and wherein readjusting the memory pool after the specified duration includes readjusting the memory pool after the time interval.

9. The method of claim 7, wherein the duration specified in the request specifies a completion criterion, and wherein readjusting the memory pool after the specified duration includes readjusting the memory pool upon meeting the completion criterion.

10. The method of claim 4, wherein dynamically and temporarily adjusting resource allocation includes readjusting the memory pool upon completion of execution of the database query.

11. The method of claim 4, further comprising determining whether to grant the request, wherein dynamically and temporarily adjusting resource allocation is performed only if a determination is made to grant the request.

12. The method of claim 11, wherein the request additionally specifies a priority, and wherein determining whether to grant the request is based at least in part on the specified priority.

13. The method of claim 11, wherein determining whether to grant the request is based upon at least one of a current system workload, available memory in the memory pool, a number of current jobs in the memory pool, a number of current threads in the memory pool, and a rate of change of activity in the memory pool.

14. The method of claim 1, further comprising generating the request using a query optimizer in connection with generating an access plan for the database query.

15. A method of performing a database query on a computer system, the method comprising:
generating an access plan for the database query, including determining an adjustment to a resource allocation in the computer system that optimizes execution of the access plan;
dynamically and temporarily applying the adjustment to the resource allocation in the computer system; and
executing the access plan while the adjustment to the resource allocation in the computer system is applied.

16. The method of claim 15, wherein the adjustment to the resource allocation in the computer system comprises allocation of an additional system resource selected from the group consisting of a memory resource, a processor resource, an input/output resource, a storage resource, and a machine resource.

17. The method of claim 15, wherein generating the access plan is performed by a query optimizer, and wherein dynamically and temporarily applying the adjustment is performed by a performance adjuster that periodically adjusts resource allocation in the computer system.

18. The method of claim 15, wherein generating the access plan further includes generating a request specifying the adjustment to the resource allocation, and wherein dynamically and temporarily applying the adjustment is performed responsive to the request.

19. The method of claim 18, wherein the database query is allocated to a memory pool in the computer system, wherein the request specifies at least one adjusted parameter for the memory pool, and wherein dynamically and temporarily applying the adjustment includes adjusting the memory pool based upon the specified at least one adjusted parameter.

20. The method of claim 19, wherein the adjusted parameter specifies a reduction in maximum activity permitted in the memory pool, and wherein dynamically and temporarily applying the adjustment includes reducing maximum activity permitted in the memory pool to that specified in the request.

21. The method of claim 19, wherein the adjusted parameter specifies additional memory to be allocated to the memory pool, and wherein dynamically and temporarily applying the adjustment includes allocating the specified additional memory to the memory pool.

22. The method of claim 19, wherein the request additionally specifies a duration, and wherein dynamically and temporarily applying the adjustment includes readjusting the memory pool after the specified duration.

23. The method of claim 19, further comprising determining whether to grant the request, wherein dynamically and temporarily applying the adjustment is performed only if a determination is made to grant the request.

24. The method of claim 23, wherein the request additionally specifies a priority, and wherein determining whether to grant the request is based at least in part on the specified priority.

25. The method of claim 23, wherein determining whether to grant the request is based upon at least one of a current system workload, available memory in the memory pool, a number of current jobs in the memory pool, a number of current threads in the memory pool, and a rate of change of activity in the memory pool.

26. An apparatus, comprising:
at least one processor;
a memory; and
program code resident in the memory and configured to be executed by the at least one processor to dynamically adjust database performance in the apparatus by receiving a request for a temporary allocation of a system resource for a database query to be executed in the future, and dynamically and temporarily adjusting resource allocation in the apparatus in response to receiving the request such that the database query is executed under the adjusted resource allocation.

27. The apparatus of claim 26, wherein the program code comprises a performance adjuster configured to periodically adjust resource allocation in the apparatus.

28. The apparatus of claim 26, further comprising a memory pool, wherein the database query is allocated to the memory pool, wherein the request specifies at least one adjusted parameter for the memory pool, and wherein the program code is configured to dynamically and temporarily adjust resource allocation by adjusting the memory pool based upon the specified at least one adjusted parameter.

29. The apparatus of claim 28, wherein the adjusted parameter specifies at least one of a reduction in maximum activity permitted in the memory pool and additional memory to be allocated to the memory pool.

30. The apparatus of claim 28, wherein the request additionally specifies a duration, and wherein the program code is further configured to readjust the memory pool after the specified duration.

31. The apparatus of claim 28, wherein the program code is further configured to determine whether to grant the request based upon at least one of a priority specified by the request, a current system workload, available memory in the memory pool, a number of current jobs in the memory pool, a number of current threads in the memory pool, and a rate of change of activity in the memory pool.

32. The apparatus of claim 26, further comprising a query optimizer configured to generate the request in connection with generating an access plan for the database query.

33. An apparatus, comprising:
at least one processor;
a memory; and
program code resident in the memory and configured to be executed by the at least one processor to determine, in association with generating an access plan for the database query, an adjustment to a resource allocation in the apparatus that optimizes execution of the access plan, to dynamically and temporarily apply the adjustment to the resource allocation, and to execute the access plan while the adjustment to the resource allocation is applied.

34. The apparatus of claim 33, wherein the program code comprises a query optimizer configured to generate the access plan, and a performance adjuster configured to dynamically and temporarily apply the adjustment to the resource allocation, wherein the performance adjuster is further configured to periodically adjust resource allocation in the apparatus.

35. The apparatus of claim 33, wherein the program code is further configured to generate a request specifying the adjustment to the resource allocation, and wherein the program code is configured to dynamically and temporarily apply the adjustment responsive to the request.

36. The apparatus of claim 35, further comprising a memory pool, wherein the database query is allocated to the memory pool, wherein the request specifies at least one adjusted parameter for the memory pool, and wherein the program code is configured to dynamically and temporarily adjust resource allocation by adjusting the memory pool based upon the specified at least one adjusted parameter.

37. The apparatus of claim 36, wherein the adjusted parameter specifies at least one of a reduction in maximum activity permitted in the memory pool and additional memory to be allocated to the memory pool.

38. The apparatus of claim 36, wherein the request additionally specifies a duration, and wherein the program code is further configured to readjust the memory pool after the specified duration.

39. The apparatus of claim 36, wherein the program code is further configured to determine whether to grant the request based upon at least one of a priority specified by the request, a current system workload, available memory in the memory pool, a number of current jobs in the memory pool, a number of current threads in the memory pool, and a rate of change of activity in the memory pool.

40. A program product, comprising:
program code configured to dynamically adjust database performance in a computer system by receiving a request for a temporary allocation of a system resource for a database query to be executed in the future, and dynamically and temporarily adjusting resource allocation in the computer system in response to receiving the request such that the database query is executed under the adjusted resource allocation; and
a computer readable signal bearing medium bearing the program code.

41. The program product of claim 40, wherein the computer readable signal bearing medium includes at least one of a transmission medium and a recordable medium.

42. A program product, comprising:
program code configured to determine, in association with generating an access plan for the database query, an adjustment to a resource allocation in a computer system that optimizes execution of the access plan, to dynamically and temporarily apply the adjustment to the resource allocation, and to execute the access plan while the adjustment to the resource allocation is applied; and
a computer readable signal bearing medium bearing the program code.

43. The program product of claim 42, wherein the computer readable signal bearing medium includes at least one of a transmission medium and a recordable medium.
